(19) United States
(12) Patent Application Publication
(10) Pub. No.: US 2010/0121879 A1
(43) Pub. Date: May 13, 2010

(54) Data Integration Portlet

(76) Inventor: Walter Greenberg, Alpharetta, GA (US)

Correspondence Address: MEHRMAN LAW OFFICE, P.C., P.O. Box 420797, ATLANTA, GA, 30342, US

(21) Appl. No.: 12/616,067

(22) Filed: Nov. 10, 2009

Related U.S. Application Data
(60) Provisional application No. 61/112,919, filed on Nov. 10, 2008.

(51) Int. Cl. G06F 17/30; G06F 21/24

(52) U.S. Cl. 707/779; 719/328; 715/780; 713/189; 707/E17.014

(57) ABSTRACT

A Data Integration Portlet (DIP) that runs inside of a portal that is already handling such tasks as user authentication, authorization, and navigation. The DIP includes a zero-footprint toolset that can connect to a database and return formatted data to the user, page by page, with various controls such as records per page, filtering, sorting, exporting, paging, and more, without extensive custom code. The DIP eliminates the need for software development of XML documents and stylesheets, custom built portlets, servlets, and applications to perform this task; and enables portal administrators to deploy rich data visualization applications in minutes by filling in two forms in a browser, a Connection form, and a Configuration form, then adding a viewer to the portal and specifying the Configuration from which it should retrieve its parameters.

### REFERENCE TO RELATED APPLICATION

This application claims priority to U.S. Provisional Patent Application Ser. No. 61/112,919 filed Nov. 10, 2008 entitled “DATA INTEGRATION PORTLET—FEATURE GUIDE,” which is incorporated herein by reference.

### TECHNICAL FIELD

The present invention is generally related to the field of information technology and, more particularly, to data acquisition and visualization.

### BACKGROUND OF THE INVENTION

It is possible to present data in an internet or intranet portal by using XML documents and stylesheets, custom built portlets, servlets, and applications. Unfortunately, current means of presenting dynamic, direct, real-time data within a portal require custom development of such XML documents, stylesheets, portlets, servlets, and applications. Such development can take weeks, months, or even years; often making the data that is requested obsolete by the time it is available. There are many solutions that address this problem. Most of such products are business intelligence systems that are very expensive, had lengthily deployment timeframes, and require a dedicated team of consultants or internal department to maintain. The report creation through most of these products is a development effort in itself requiring very skilled resources. What is needed is a simple toolset that allows one to simply connect to a data source, and easily configure a dataset for viewing by the end user. The installation of the product should take no more than one half hour and allow data to be displayed in the portal within minutes. Additionally the data that is displayed should have a consistent format and controls for filtering and working with the displayed information should be consistent in their functionality so users can become acclimated and not require extensive training to use the product. Further, the application should provide a means of passing the queried data to a JavaScript API at the discretion of the administrator when configuring the data view, and/or the end-user at runtime. Further the application should be “Zero-Footprint” meaning that a database is not required to store the applications configuration information.

### SUMMARY OF THE INVENTION

The present invention meets the needs described above, the DIP application is a zero-footprint software toolset that can connect to a database, and return formatted data to the user, page by page, with various controls such as records per page, filtering, sorting, exporting, paging, and more, all without having to write custom code, with the exception of some basic database structured query language (SQL), and potentially one line of JavaScript. This enables portal administrators to finally deploy rich data visualization applications by simply filling in two forms in a browser, a Connection form, and a Configuration form, then adding a viewer to the portal and specifying the Configuration from which it should retrieve its parameters. By eliminating the need for software development of XML documents and stylesheets, custom built portlets, servlets, and applications to perform this task; and further by running inside of a portal that is already handling such tasks as user authentication, authorization, and navigation; deployment of rich data visualization applications is truly accomplished in minutes rather than weeks, months, or even years. All user and administrator interfaces are web-browser based. The structured presentation of the data is consistent although the colors, fonts, border, etc. may be manipulated through stylesheets allowing the customer to configure such display attributes as desired to fit the look and feel of their particular portal. In its current incarnation the invention is a software product that is comprised of three Java JSR 168 compliant portlets and Java servlets and runs in a portal. However, the virtually identical functionality can also be created in any other suitable programming language or software environment. Therefore, while the descriptions and examples herein reference portals, portlets, and Java; the actual deployment of the software invention could be delivered on any appropriate platform.

### BRIEF DESCRIPTION OF THE DRAWINGS

FIG. 1 is an architectural overview of the entire DIP Application system and explains how the various system components interrelate to configure and deliver rich data visualization capabilities to the portal user.

FIG. 2 is a screenshot of the DIP Connection Manager interface. The Connection Manager is used to make database connections; these connections are then used by the Configuration Manager to configure the output of the data to the portal.

FIG. 3 is a screenshot of the import Connection interface that is used to import connections that have been created by a connection manager, either locally or by another party.

FIG. 4 is a screenshot of the Connection form; this is one of two forms that control the flow of data from the database to the Portal users.

FIG. 5 is a screenshot showing the robust built in help facility that embeds help text exactly where it's needed.

FIG. 6 is the password prompt that is presented when attempting to view, edit, or delete a protected connection.

FIG. 7 shows the architecture and on-save event processing that saves the connection parameters to the encrypted XML file on creation or updating of a connection profile.

FIG. 8 is a screenshot of the Integration Manager interface which is where the queries and options for the DIP are configured.

FIG. 9 is a popup window that is shown for importing DIP configurations.

FIG. 10 shows the security and Query sections of the DIP Configuration Profile.

FIG. 11 is an interface for using a hidden DIP Connection.

FIG. 12 is a password prompt for accessing a DIP Connection that is not hidden, but is protected.

FIG. 13 shows the Grid Configuration interface that is used to determine what data from the query will be shown to the end user. It is the last of the required section for publishing the DIP.

FIG. 14 is the Global Options section of the Configuration Profile. This is where the formatting and display options are configured.

FIG. 15 is the DIP Actions interface. Actions actually allow the user to pass data from the query to a JavaScript function in the portal. This component makes the DIP a very powerful tool to work with third party JavaScript APIs.

FIG. 16 shows the Filters section of the DIP Configuration Profile. Filters allow end-users to quickly get to the information they need.

FIG. 17 is a continuation of the Filter Section interface.

FIG. 18 shows the Header/Footer and Stylesheet sections. The header and footer allow one to display information above, centrally, and below the output table.

FIG. 19 is a screenshot off one half of the DIP Configuration Profile for purposes of getting an overall sense of what is presented to the DIP Configuration Administrator.

FIG. 20 is the second half of the DIP Configuration Profile to serve the same purpose as FIG. 19.

FIG. 21 is a screenshot showing the robust built in help facility for the Configuration Profile that embeds help text exactly where it's needed, just like on the Connection Profile.

FIG. 22 shows the architecture and on-save event processing that saves the configuration parameters to the encrypted XML file on creation or updating of a configuration profile.

FIG. 23 shows the copy feature of the Configuration Manager which permits the Configuration Administrator to copy an existing Configuration as a starting point for creating a new DIP.

FIG. 24 is a screenshot of the DIP Viewer Named Portlet Instance with which the end-user shall interact to view the information as configured in the assigned (mapped) configuration. It also demonstrates the Action sending query data to a JavaScript charting API.

FIG. 25 is another DIP Viewer Named Portlet Instance that demonstrates the Date Range filter and column formatting.

FIG. 26 shows a DIP Viewer Named Portlet Instance that is facilitating the mapping of points (hospitals) to an ESRI map leveraging the ESRI JavaScript API.

FIG. 27 demonstrates the ability of the DIP Viewer Named Portlet Instance to support cascading or dependent filtering, and the display of detailed information within the portlet for a given record.

FIG. 28 is the detail that is displayed when “Detail in new window” is configured.

FIG. 29 is intended to show an overview of the portal leveraging DIP technology.

### DETAILED DESCRIPTION OF THE EXEMPLARY EMBODIMENTS

Turning now to the figures, in which like element numerals refer to like elements throughout the several figures, a particular embodiment of the DIP is shown in the figures and described in the accompanying text.

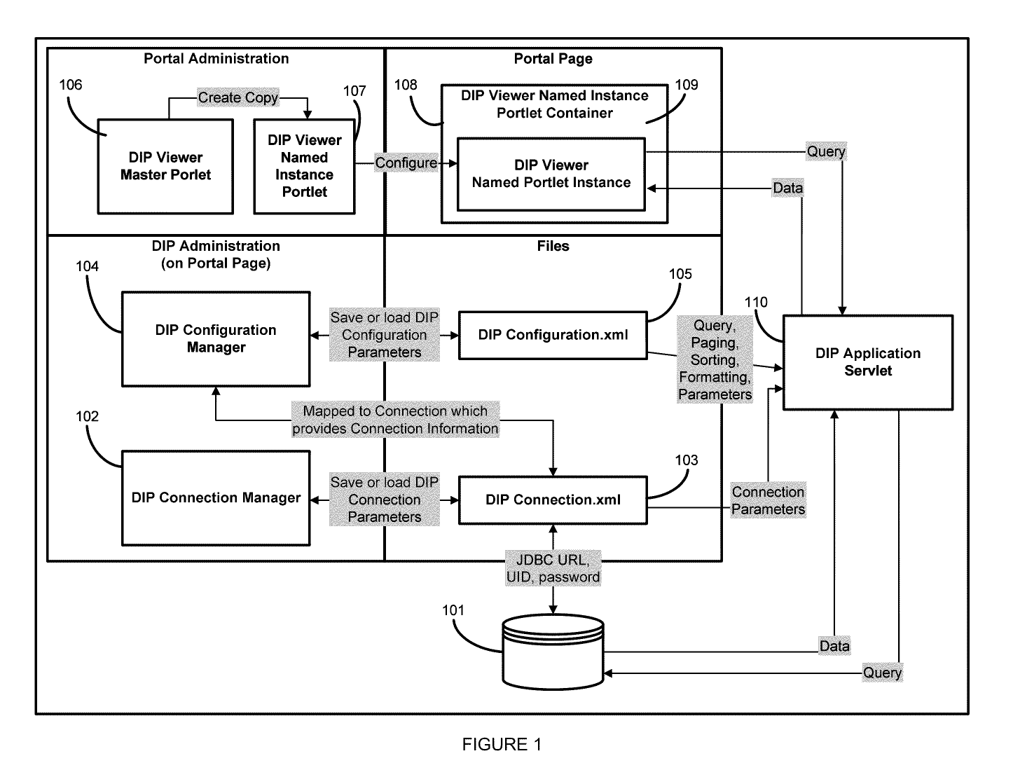

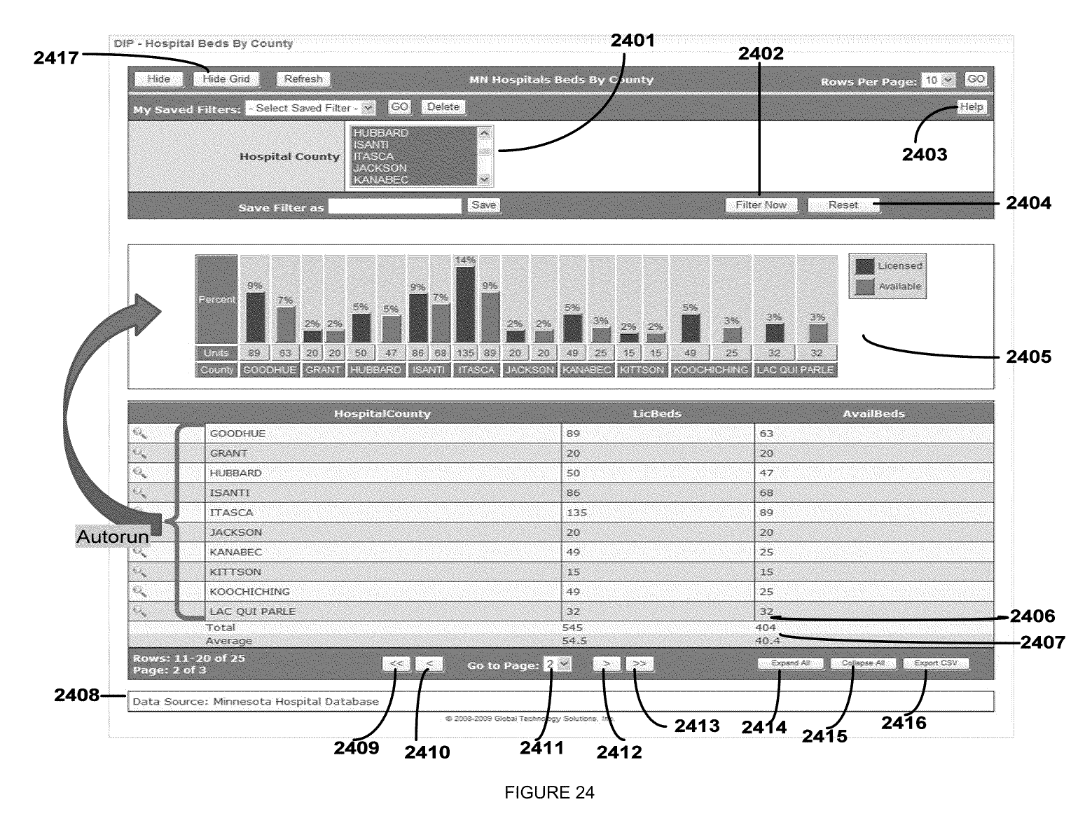

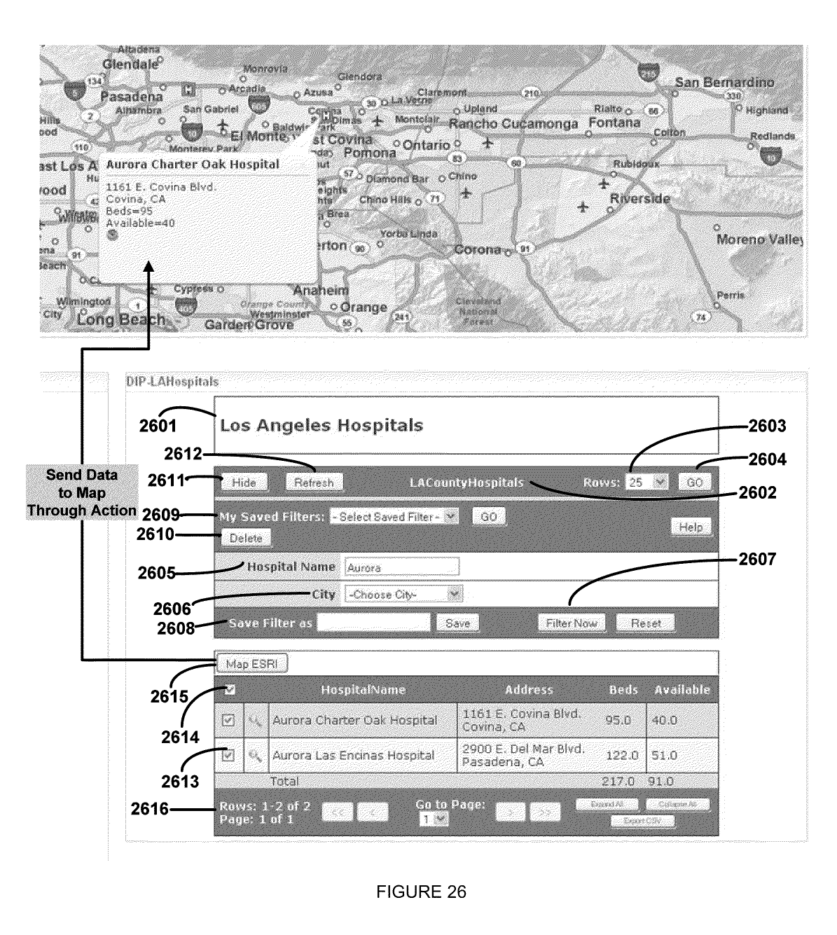

FIG. 1 is an architectural overview of how the DIP application and its various components function. 101. The Database: The DIP itself does not require a database to run. All configurations and settings for the DIP software are stored in XML documents on the server [item 103 & 105 below]. It simply connects to databases, and facilitates visualization and usage of the data within the portal with no coding through a configuration and administrative interface. 102. The DIP Connection Manager: The DIP Connection Manager is where users enter the database connection information to connect to the data. Because the DIP Connection Manager is separate from the DIP Configuration Manager, a privileged user can create the connection, and then other users can leverage the connection to Configure DIPs without needing to know any of the connection particulars. The connection is made by entering a JDBC connection string and authentication information into a form, naming the connection and saving it. For details on the connections, please see “Creating a DIP Database Connection”. 103. Connection XML: All DIP Connection parameters are stored in the Connection XML document in a protected directory on the server. 104. The DIP Configuration Manager: The DIP Configuration Manager is where users configure the connection, query, and visualization options for a particular DIP data view (called a DIP). Users select a connection and then create a query. The query may consist of a select statement or a call to a stored procedure in the database. The query is tested and any columns of data are returned to the interface to be configured for visualization within the DIP. For details on the various configuration options, please see FIGS. 8 through 23. 105. Configuration XML: All DIP Configuration parameters are stored in Configuration XML documents in a protected directory on the server. 106. The DIP Viewer: The DIP Viewer is the runtime component that displays the information that has been configured. The DIP Viewer Portlet is an HTML page that calls several JavaScript files. The DIP Viewer portlet is typically copied and then the copy is named something that identifies its function (like “DIP —LA City Police Departments”). Was one to just assign the “LA City Police Department” configuration to the DIP Viewer itself, rather than a copy, then the DIP Viewer would be mapped to that configuration and would display that same configuration each time it was added to a page. In order to allow for many different DIP configurations to be displayed on many separate pages within the portal, each DIP Configuration requires that a copy of the DIP Viewer be created in the portal portlet administration interface (DIP Viewer Named Instance) this copy is then called the DIP Viewer Named Instance. 107. The DIP Viewer Named Instance: The DIP Viewer Named Instance is added to a page. Then it is configured by clicking the “Configure” option on the [108] portlet container menu. A dropdown list of available Configurations is presented. From this list, the desired The DIP Viewer Named Instance is selected and the selection is submitted. The configured The DIP Viewer Named Instance is called the DIP Viewer Named Portlet Instance as it utilizes the Portlet Container ID to differentiate itself from other DIP Viewer Named Portlet Instances. 109. DIP Viewer Named Portlet Instance: DIP Viewer Named Portlet Instance is where the configured information is displayed to the user. The DIP Viewer has many data visualization controls that the user can specify if they are permitted through the configuration. Such characteristics are filtering, paging options, downloading, viewing details of row based records, mapping, charting, and more. For more examples of some of the DIP Viewer Named Portlet Instance features, please see FIGS. 24 through 28. When the DIP Viewer Named Portlet Instance is loaded, JavaScript functions on the page call the [110] DIP Java Servlet sending it the DIP Configuration ID. The Java Servlet then makes the query to the database and calculates the number of records returned and divides this number by the number of records to be displayed per page, then queries those records that correspond to the selected page number (see FIG. 26, item 2603). The Java Servlet then returns the data and the configuration parameters to the JavaScript function. The JavaScript function then performs a loop to write the records as table rows and the specified detail in alternate rows below the row to which the detailed information applies. It then renders the various page controls (see FIGS. 24 through 28 for details).

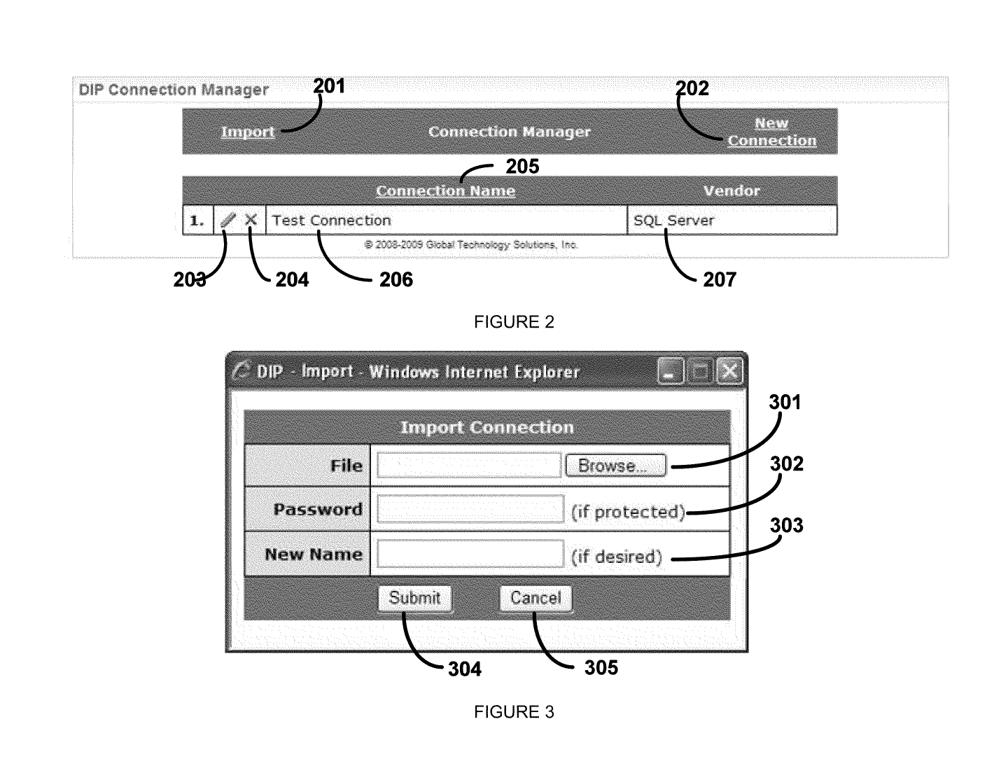

FIG. 2 is a screenshot of the DIP Connection Manager interface. The Connection Manager is used to make database connections; these connections are then used by the Configuration Manager to configure the output of the data to the portal. 201. Import: Connections produced with the DIP are saved as encrypted XML files. These files may be password protected and may be imported into another (or same) instance of the DIP. See FIG. 3 for more information. 202. New Connection: This link is clicked to create a new Connection Profile. 203. The pencil icon is the universal control to click when one desires to edit a profile. If the DIP Connection is password protected, the system will prompt the user for the password (see FIG. 6). 204. The red X is the universal symbol for delete. If the DIP is password protected the user will be prompted for the password (FIG. 6), the user will additionally be prompted to confirm that wish to permanently delete the connection. 205. The label of the Connection Name column will cause the sorting of connections to go from ascending sort to descending sort order and vice versa when clicked. 206. The connection name is displayed as stored in the Configuration parameters. 207. The Vendor column displays the database that has been specified in the Connection profile.

FIG. 3 is a screenshot of the import Connection interface that is used to import connections that have been created by a connection manager, either locally or by another party. Importing consists of four easy steps: 301. Select the desired XML Connection file from the hard drive on the local machine. 302. Is the file is password protected, then the password must be entered. 303. If importing a Connection that already exists in the Connection Manager a new name must be specified, or a new name may be specified regardless if desired. 304. Click Submit to begin the import process, the user will be notified of success or failure with a message box. 305. The import may be canceled at any time prior to clicking submit.

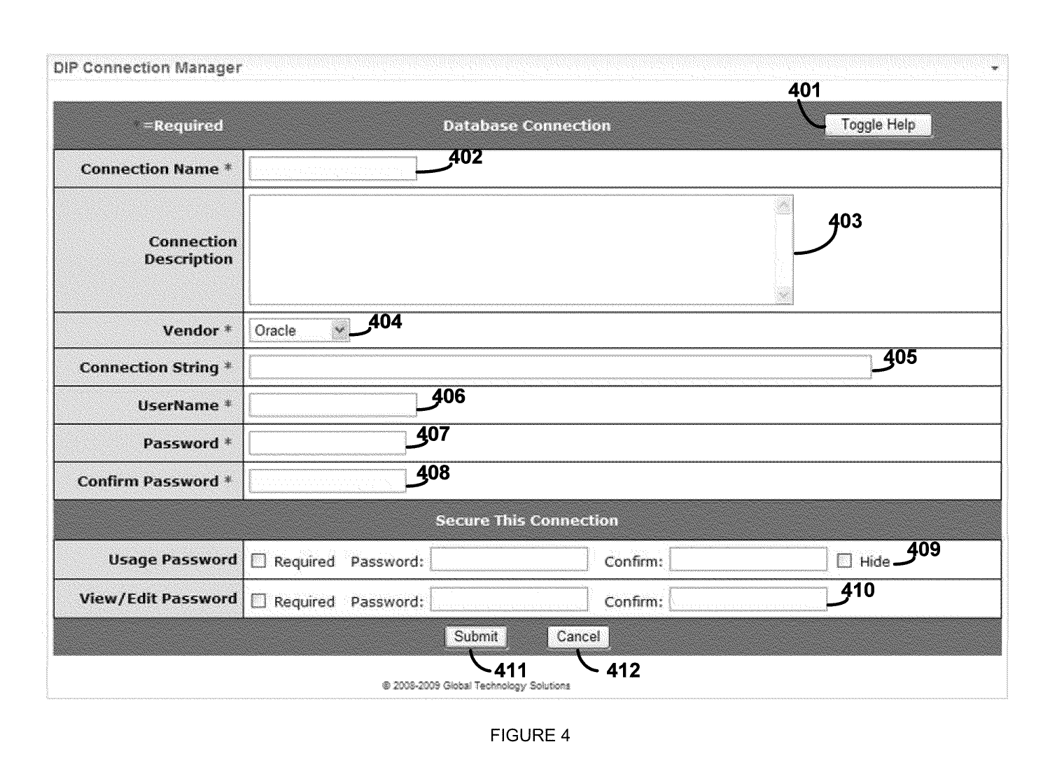

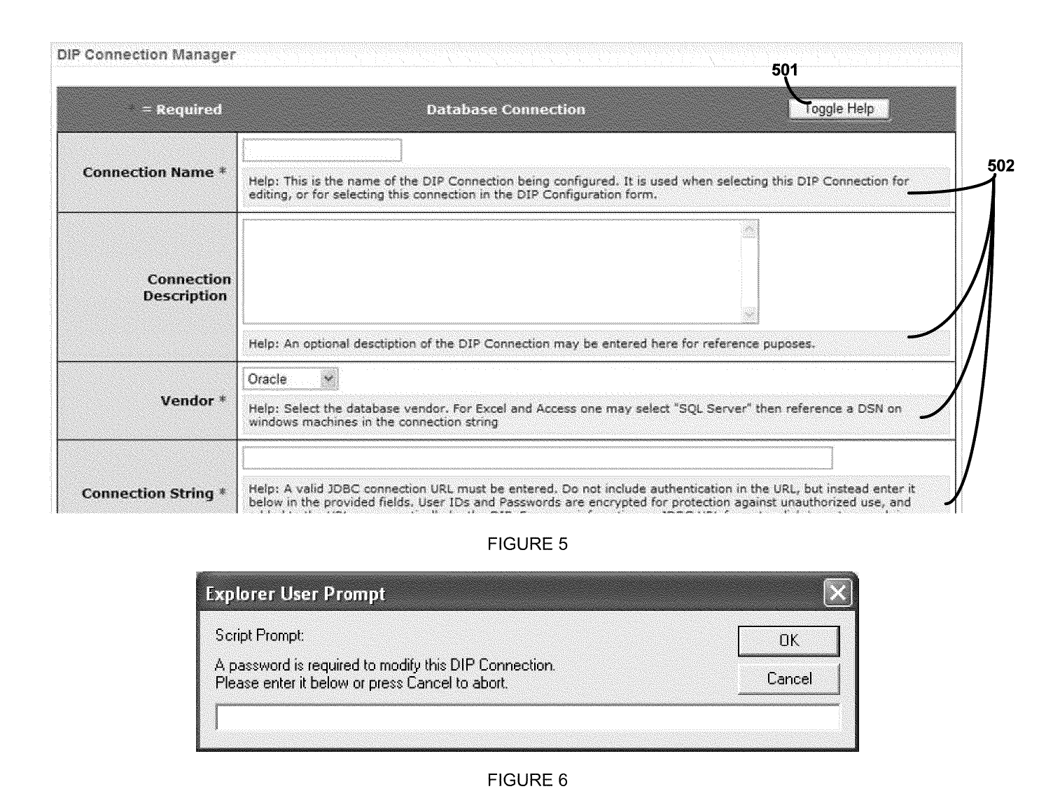

FIG. 4 is a screenshot of the Connection Profile; this is one of two forms that control the flow of data from the database to the Portal users. The Connection Profile is selected from a dropdown list when creating a configuration 401. The Toggle Help button turns on and off context driven help. See FIG. 5 for details. 402. Connection Name: This is the name of the DIP Connection being configured. It is used when selecting this DIP Connection for editing, or for selecting this connection in the DIP Configuration form. It is required. 403. Connection Description: An optional description of the DIP Connection may be entered here for reference purposes. 404. The database vendor is selected (IBM DB2, Oracle, Sun MySQL, or Microsoft SQL Server). For Excel and Access, one may select “SQL Server” then reference a DSN on windows machines in the connection string. 405. Connection String: A valid JDBC connection URL must be entered. Authentication is not included in the URL, but instead is entered below in the provided fields. User IDs and Passwords are encrypted for protection against unauthorized use, and added to the URL programmatically by the DIP. For more information on JDBC URL formats, a link is provided to launch a preformatted Google search for JDBC URL syntax in a new window. 406. Username: If the connection requires authentication, the user name is entered. It is encrypted on save, and cannot be recovered through the interface. 407. Password: If the connection requires authentication, the password is entered. It is encrypted on save, and cannot be recovered through the interface. 408. Confirm Password: The password is re-entered and must match to save the Profile. 409. Usage Password: Usage of the Connection can be restricted by selecting “Required”, then entering and confirming a Password. The hide checkbox, delists the Connection from the Connection dropdown list in the Connection form, instead the user must select “Use Hidden Connection” and must know the connection name and password to use it. 410. View/Edit Password: This is used to require the user to enter a password in order to open, edit, or import the connection, required must be checked and a password must be entered and confirmed. The password will be utilized in the encryption key of the profile and the profile cannot be used or recovered without it. 411. Submit: When the Submit button is pressed, validation is performed to ensure that required fields have been filled and that the password and confirm fields match. If a View/Edit Password has not been set, then the Connection will be encrypted using the included default hash key; otherwise the password will be included as part of the hash key and if lost the connection will not be recoverable. In such event the html file would be deleted from the hard drive of the server and a new connection would be created. 412. Cancel: Pressing cancel will prompt the user that any unsaved changes will be lost, and then upon acceptance, will return the user to the Configuration Manager View.

FIG. 5 is a screenshot showing the robust built in help facility that embeds help text exactly where it's needed. Detailed help is shown under each field to walk the user through successful completion of the DIP Connection Profile.

FIG. 6 is the password prompt that is presented when attempting to view, edit, or delete a protected Connection Profile.

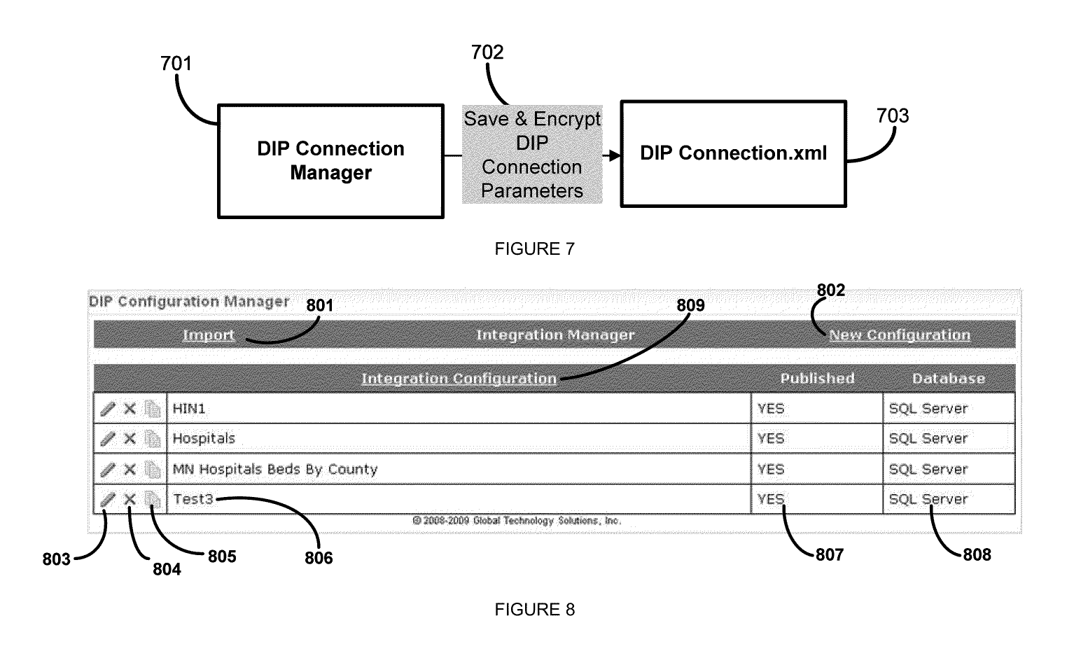

FIG. 7 shows the architecture and on-save event processing that saves the connection parameters to the encrypted XML file on creation or updating of a connection profile. 701. The DIP Connection Manager calls on the DIP application [702] to create or update and encrypt the DIP Connection Parameters into the Connection XML Document [703].

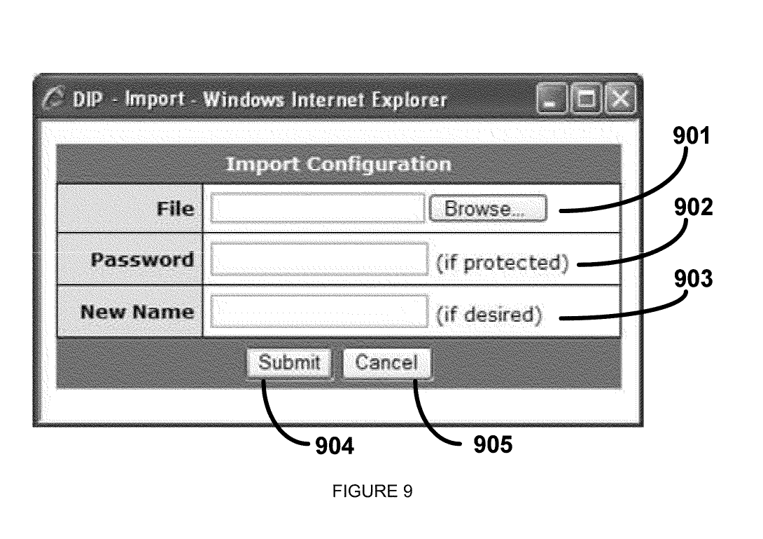

FIG. 8 is a screenshot of the Integration Manager interface which is where the queries and options for the DIP are configured. 801. Import: Configurations created both locally and with other DIP systems may be imported. In cases where the Connection specified in the imported configuration is not available, it may be necessary to edit the connection. See FIG. 9. 802. New Configuration: Opens a Configuration Profile for filling. 803. The pencil icon is the universal control to click when one desires to edit a profile. If the DIP Configuration is password protected, the system will prompt the user for the password (similar to FIG. 6). 804. The red X is the universal symbol for delete. If the DIP Configuration is password protected the user will be prompted for the password (FIG. 6), the user will additionally be prompted to confirm that wish to permanently delete the configuration. 806. The name of the Configuration; they must be unique. 807 & 808. These columns have information about the configurations. 809. The label of the Integration Configuration column will cause the sorting of configurations to go from ascending sort to descending sort order and vice versa when clicked.

FIG. 9 is a screenshot of the import Configuration interface that is used to import

Configurations that have been created by a Configuration Manager, either locally or by another party. Importing consists of four easy steps: 901. Select the desired XML Configuration file from the hard drive on the local machine. 902. Is the file is password protected, the password must be entered. 903. If importing a Configuration that already exists in the Configuration Manager a new name must be specified, or a new name may be specified regardless if desired. 904. Click Submit to begin the import process, the user will be notified of success or failure with a message box. 905. The import may be canceled at any time prior to clicking submit.

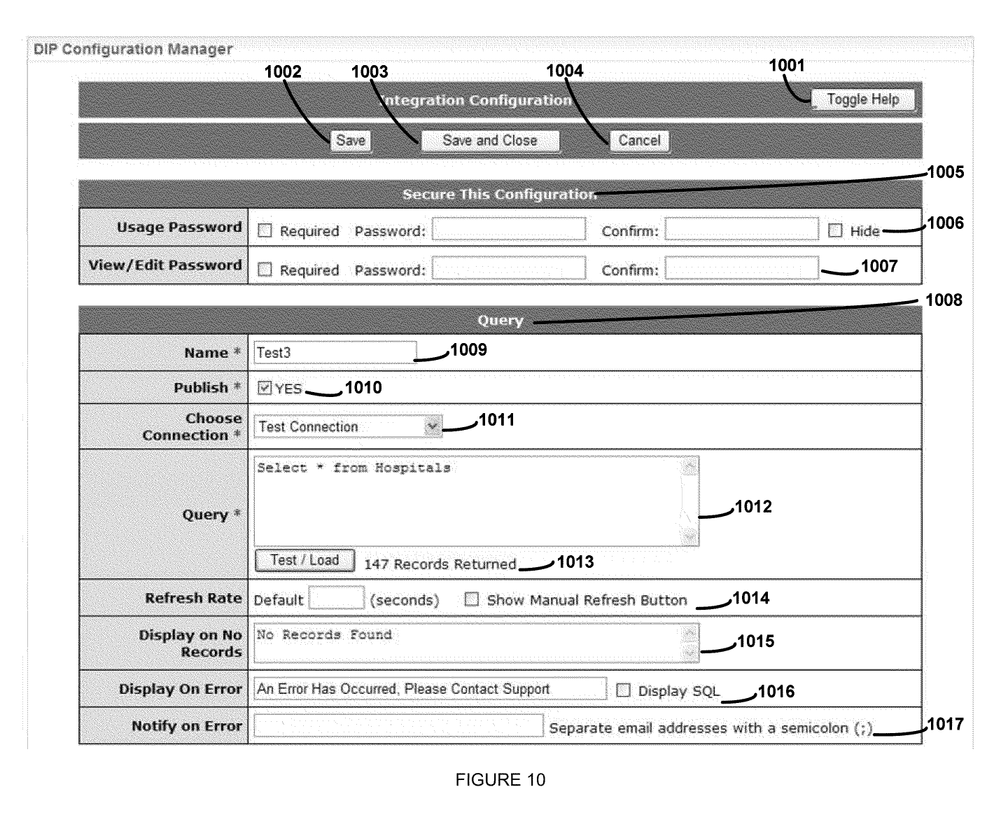

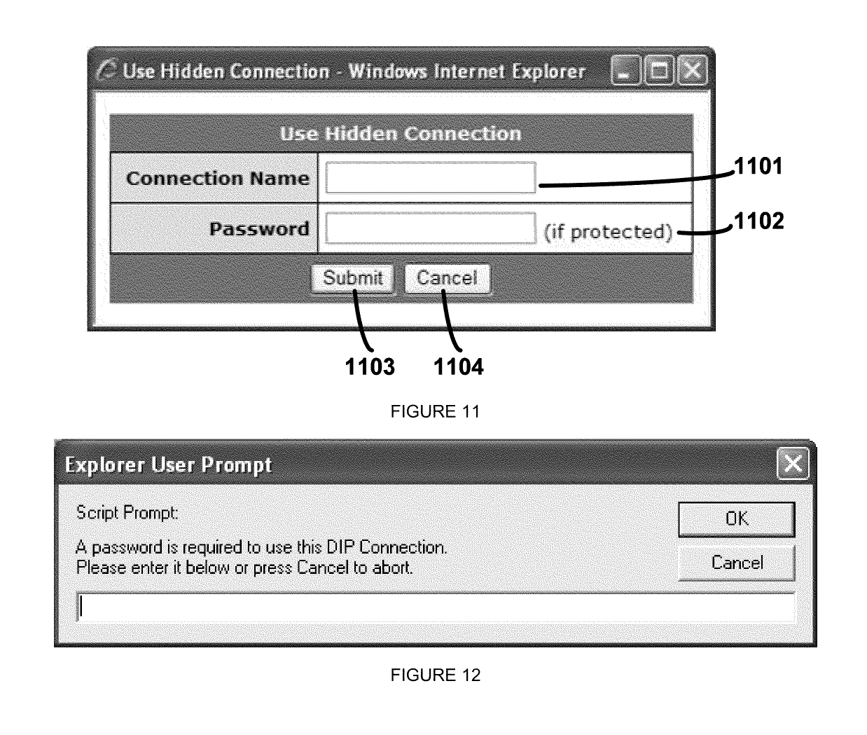

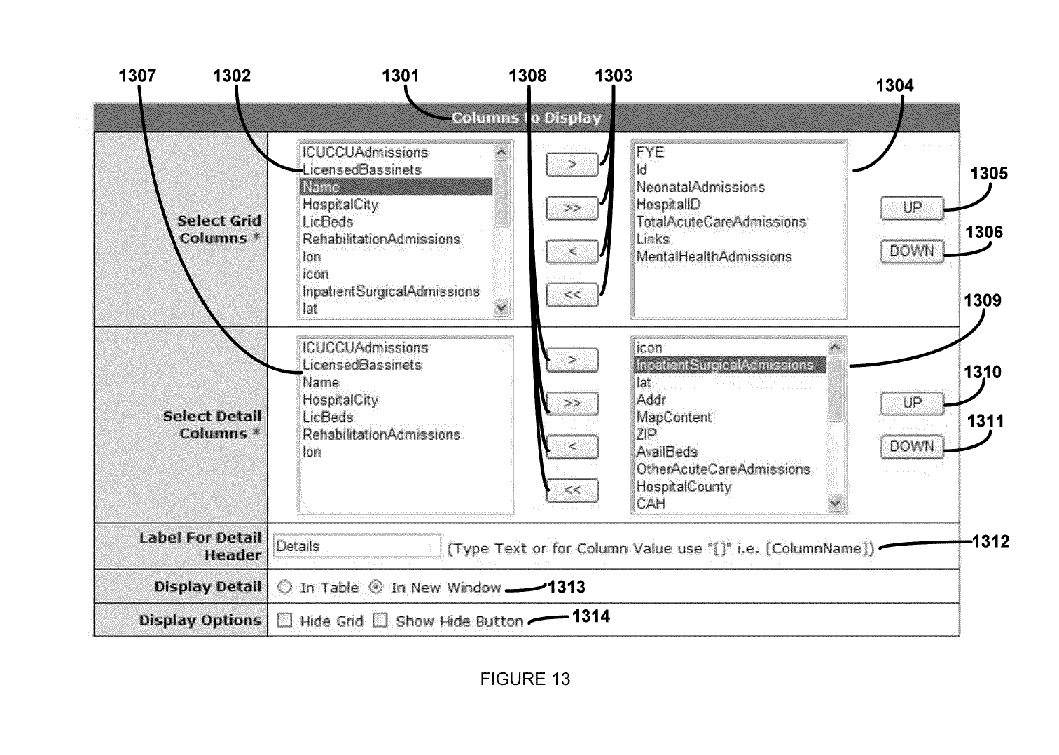

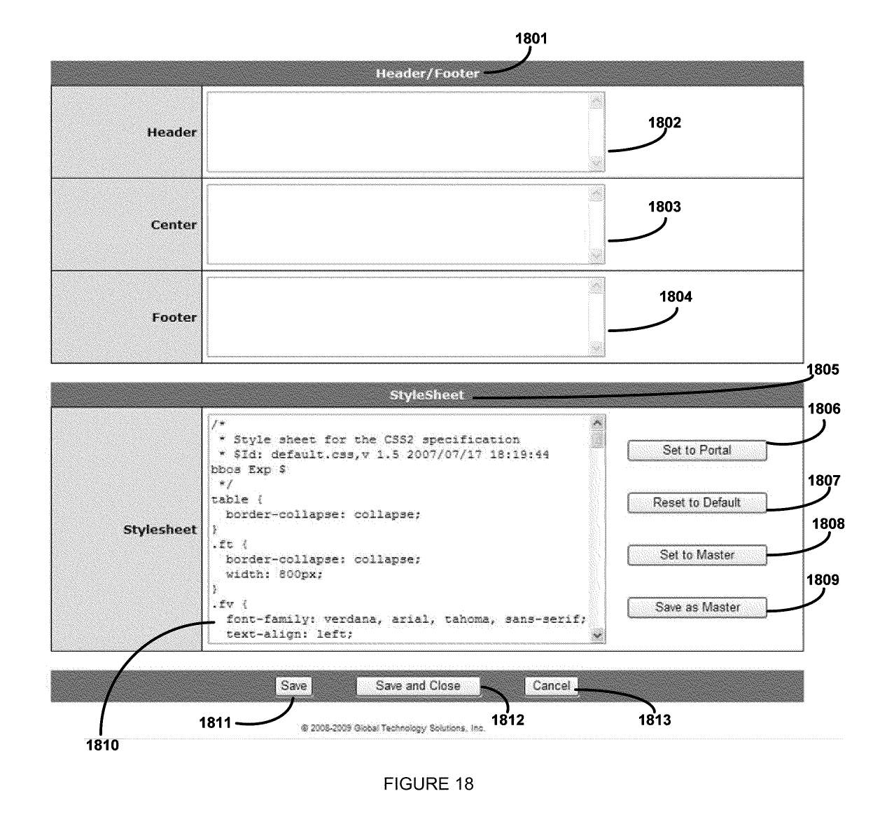

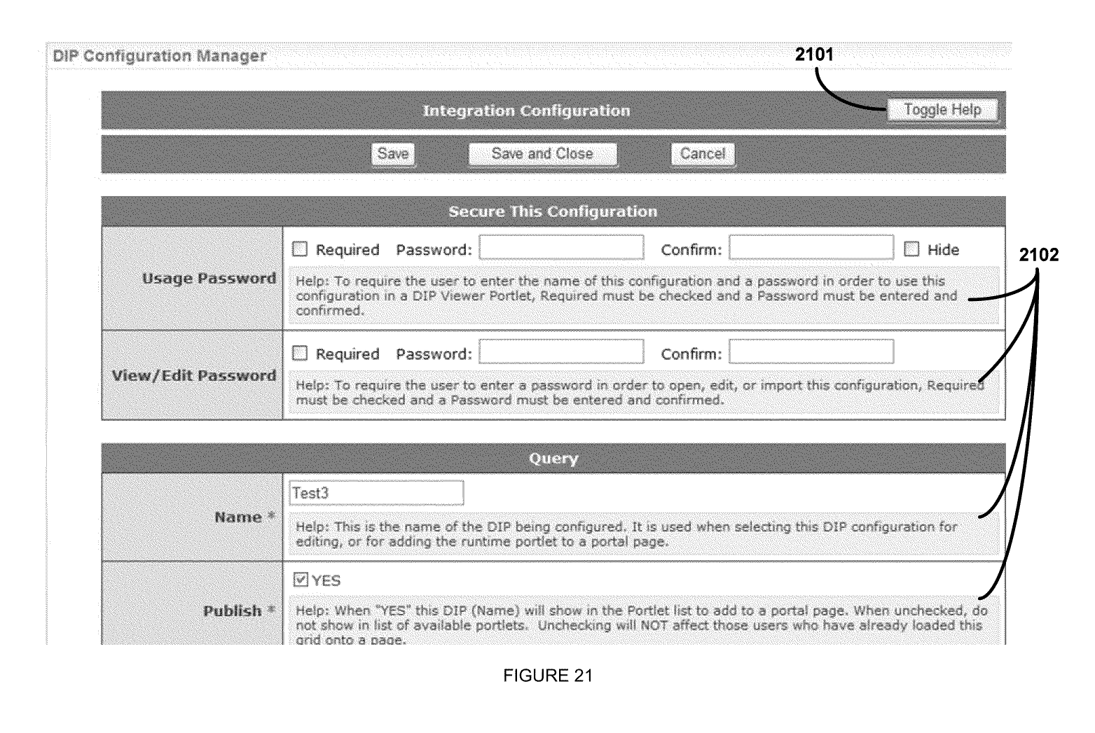

FIG. 10 shows the security and Query sections of the DIP Configuration Profile. 1001. Toggle Help: The Toggle Help button turns on and off context driven help. See FIG. 21 for details. 1002-1004. Save and Cancel buttons are presented at both the top and bottom of the form. See FIG. 18 for more details. 1005. The security section allows one to secure the Configuration Profile with a password. 1006. Usage Password: To require the user to enter the name of this configuration and a password in order to use this configuration in a DIP Viewer Portlet, Required must be checked and a Password must be entered and confirmed. Checking Hide will require the user to enter the name and password of the configuration in order to add it to a portal page. 1007. View/Edit Password: To require the user to enter a password in order to open, edit, or import this configuration. Required must be checked and a Password must be entered and confirmed. The password will be utilized in the encryption key of the profile and the profile cannot be used or recovered without it. 1008. Query Section: This is where all parameters will be specified to acquire the data. 1009. Name: This is the name of the DIP being configured. It is used when selecting this DIP configuration for editing, or for adding the runtime portlet to a portal page. 1010. Publish: When “YES” this DIP (Name) will show in the Portlet list to add to a portal page. When unchecked, do not show in list of available portlets. Un-checking will not affect those users who have already loaded this grid onto a page. 1011. Select desired connection from the list of connections that have been configured for this portal in the DIP Connection Manager. If one chooses “Use Hidden Connection, they will be prompted for a username and password (see FIG. 11). 1012. A valid SQL Select statement or Stored Procedure call must be entered for the DB platform of the connection. For Stored procedures: 1. Assume that the name of the stored proc is “sp_test_proc”. To call the procedure without any parameters, the main query would be: {call sp_test_proc}. With hard-coded parameters, it would look something like: {call sp_test_proc(paramName1, paramName2)} To use parameter tokens, it might look like the formatting below: {call sp_test_proc([PARM:paramName1], [PARM:paramName2])} or {call sp_test_proc([DATE:from], [DATE:to])} One thing to note, the “Clause” field when defining a filter is ignored if you are calling a stored procedure, however a required field so you have to enter some text in there. This will be fixed in the next maintenance release. Query tokens. There are four tokens for Queries:[UID],[UNAME],[QRY:],[SESS:]. The syntax for [UID] and [UNAME] is as follows: You can use the tokens where you want to insert information about the current user. Example: Select from table where reader=[UID]. [UID] will be replaced with the logged in user's id (in portal). [UNAME] will be replaced with the logged in user's name (in portal). The syntax for [QRY] and [SESS] is as follows: You can use these tokens where you want to insert parameters from current requestURL or requestSession. Example: Select from table where field1=[QRY:paramName]. These tokens will provide parameter information from the request. [QRY:paramName] will be replaced with query string variable where name=paramName. [SESS:paramName] will be replaced attribute with name=paramName from the request session. 1013. Test/Load: This button will execute the query and display how many records are returned, it will also place all of the column names from the query into the “Columns to Display” section (see FIG. 13, items 1302 and 1307). 1014. Refresh Rate: If left empty then the DIP will not auto-refresh, otherwise the DIP view will refresh in number of seconds entered. If “Show Manual Refresh Button” is checked, then the “Refresh” button will be available on the DIP. 1015. Display on No Records: The text entered here will be displayed to the user if the query returns an error. 1016. Display on Error: The text entered here will be displayed to the user if the query returns an error. 1017. If email addresses are entered and an SMTP server is specified in the DIP system settings, then an email message will be sent with the returned error, date/time, URL, and DIP name.

FIG. 11 is the dialog box for using a hidden connection. 1101. Enter the desired connection name. 1102. Enter password if protected. 1103. On submit the system will seek the requested connection, if found, the password will be checked and the Connection will be returned. If the connection is not found or the password does not match the user receives the message, “The Connection you requested could not be opened, please check the name and password and try again.” 1104. Cancel: The operation may be canceled any time prior to Clicking Submit.

FIG. 12 is a password prompt for accessing a DIP Connection that is not hidden, but is protected.

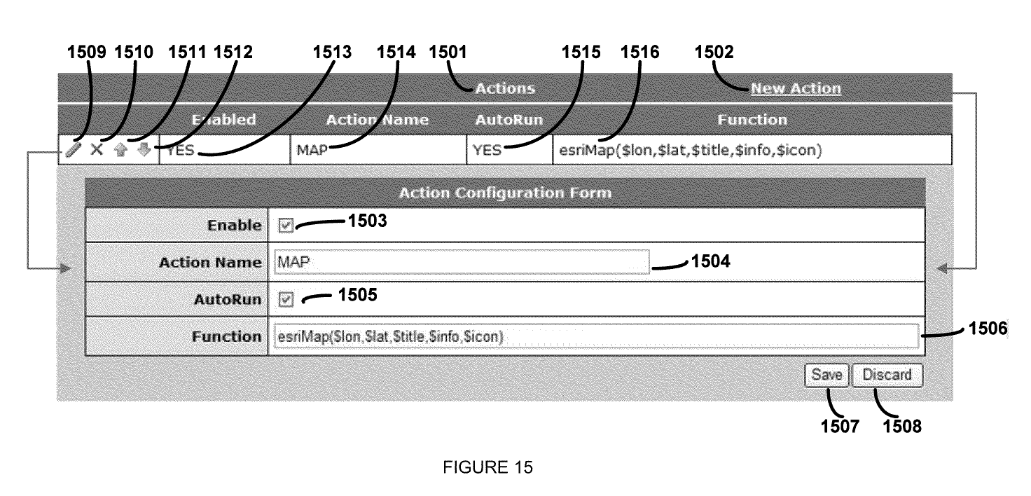

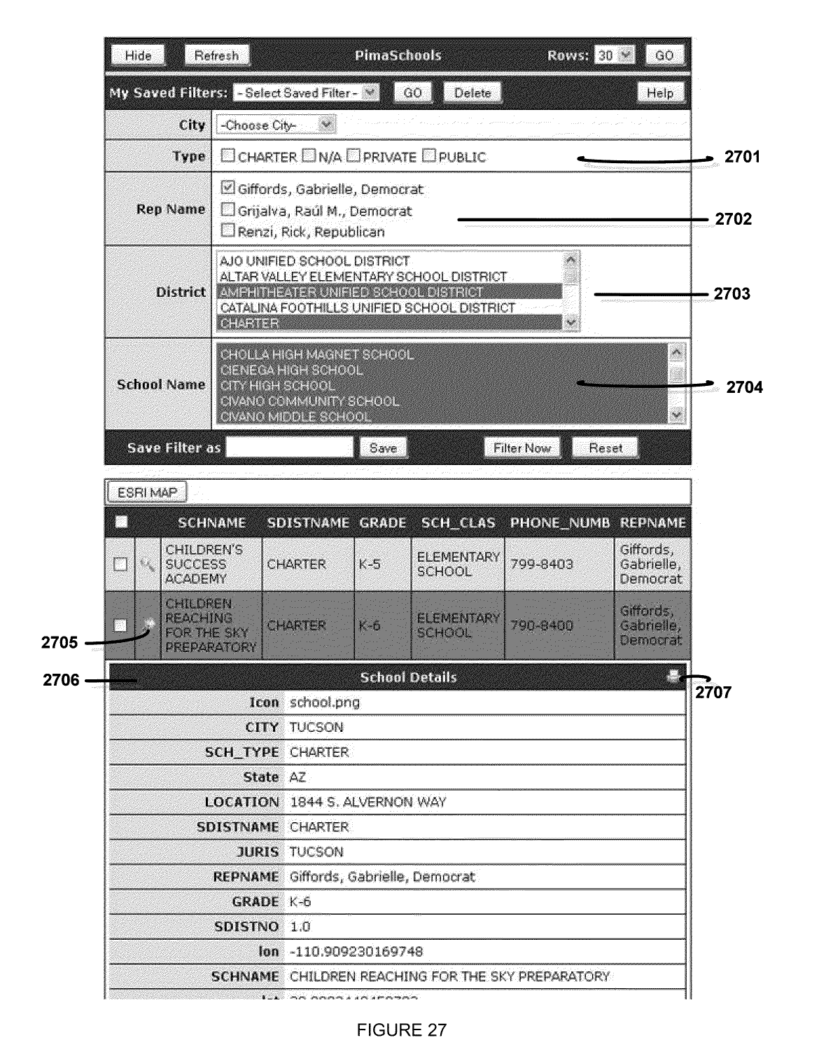

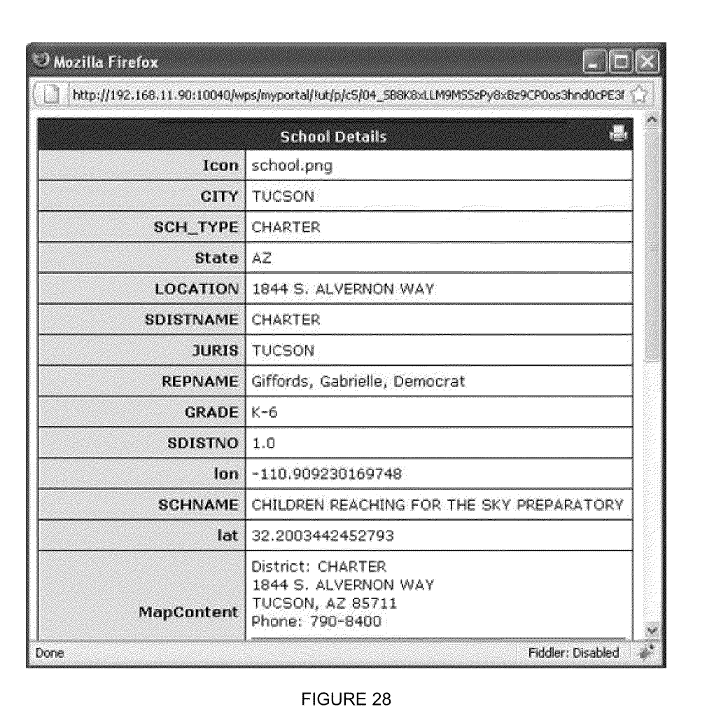

FIG. 13 shows the Grid Configuration interface that is used to determine what data from the query will be shown to the end user. It is the last of the required section for publishing the DIP. 1301. Columns to Display: Header for section. 1302. A list Column names from the query that will appear as table columns in the Viewer once added [to 1304] using the button controls. 1303. Button Controls: “>” is to add selected items, “>>” adds all items, “<” is remove selected item, and “<<” is to remove all items from 1304. 1304. These are the query columns whose values that be shown in the grid columns in the viewer. 1305 & 1306. These controls order the selected columns up and down which move the viewer columns left and right respectively. 1307-1311. Functions the same as 1302-1306 except that the selected columns shall be displayed in the detail section, rather than as columns in the Viewer. (see FIG. 27 and FIG. 28 for more on the display of the detail section). 1312. Label for Detail Header: The value entered here will be displayed in the header of the detail display table. 1313. Display Detail: This selection determined whether to display the detail items in the table itself or in a new popup window (FIGS. 27 & 28). 1314. Display Options: Hide Grid and Show Hide button are useful when using the DIP for charting or mapping with the Autorun feature of the Action (see FIG. 15). If Show Hide Button is selected here, it will display on the Viewer as in FIG. 24, item 2417.

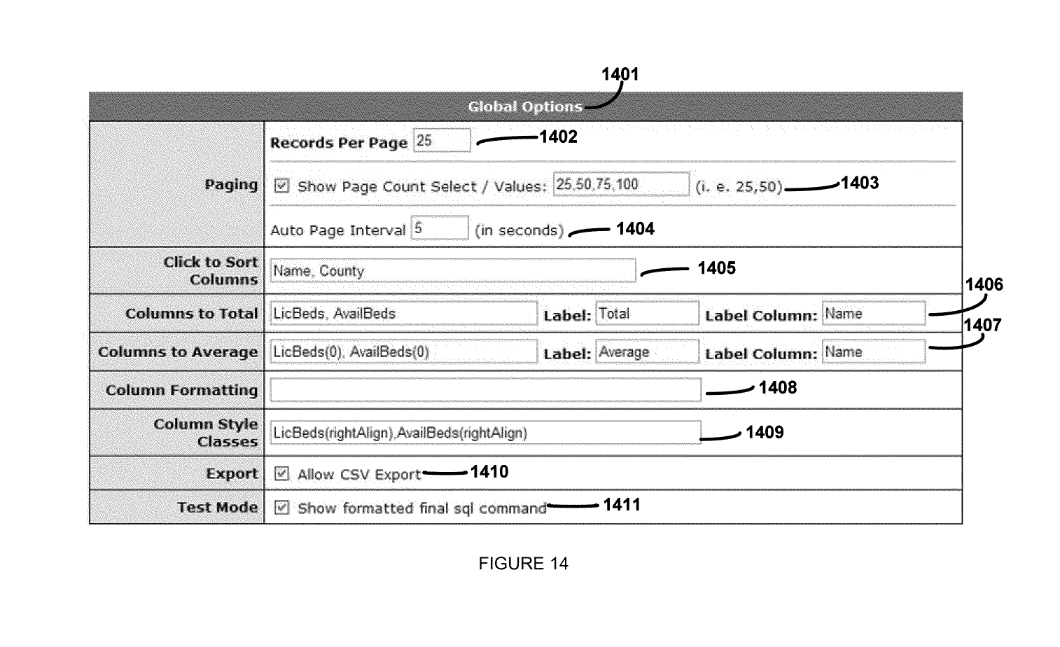

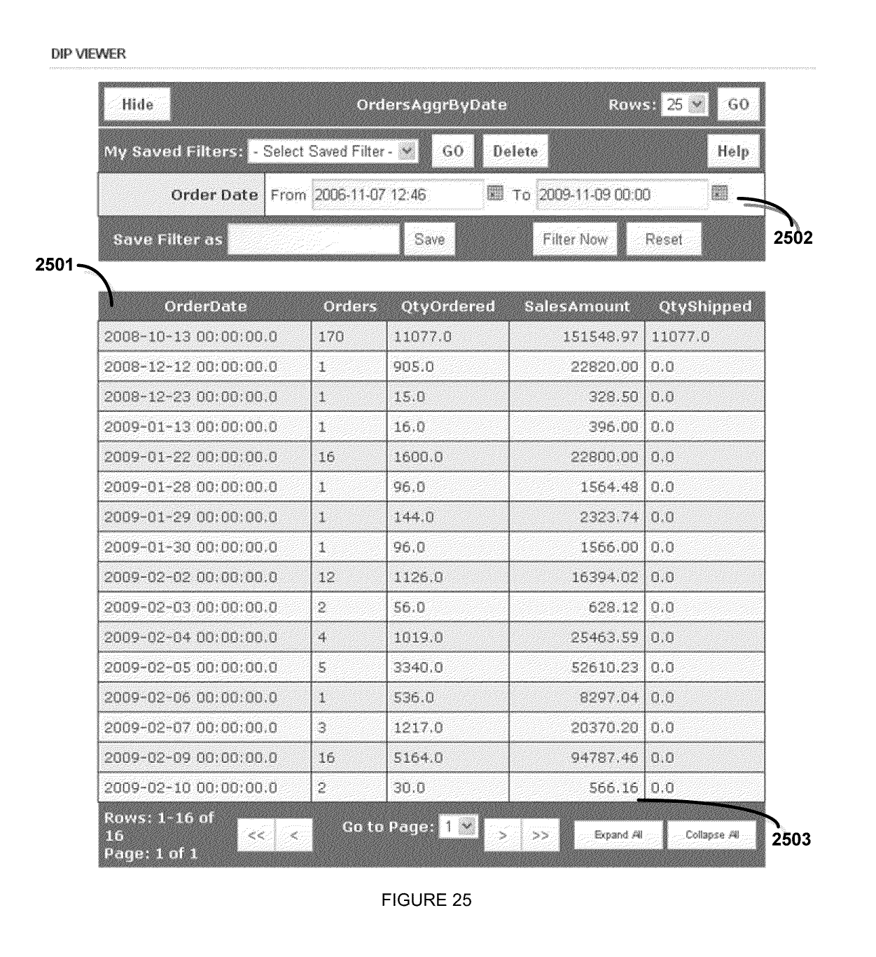

FIG. 14 is the Global Options section of the Configuration Profile. This is where the formatting and display options are configured (1401). 1402. Records per Page: Determines how many records will be displayed on a page by default in the Viewer. 1403. If show page count is selected it will show the control in the view as seen if FIG. 27, item 2707. The values field will determine what row count values may be shown in the dropdown (2707). 1405. Click to Sort Columns: Any Column Names from the Query entered here will activate the sort link at the top of the column in the Viewer so the user can “Click to Sort” like “OrderDate” in FIG. 25, item 2501. 1406. Columns to Total: When specified for numeric columns, will total those columns listed at the bottom of the table. The label entered will be presented at the bottom of the column specified (see FIG. 24, item 2406). 1407. Columns to Average: Similar to totals above with the exception that the number of decimal points may be specified in parenthesis, and averages instead of totaling. An example of the effect can be seen in FIG. 24, item 2407. 1408. Column Formatting: A complete reference is included for column formatting, wherein the user may format dates, numbers, currency, and text to many different national standards. 1409. Column Style Classes: Specific CSS classes may be added in parenthesis following the column name to apply them in the Viewer. This is useful for alignment (i.e. numbers to the right), and emphasis. For the effect of this parameter, please see FIG. 25, item 2503 where the numbers have been right aligned using this feature. 1410. Export: Checking this box places an Export button on the footer bar of the viewer. See FIG. 24, item 2416 for the runtime effect. 1411. Test Mode: Test mode will display the SQL command that is sent to the database server in the Viewer for troubleshooting purposes.

FIG. 15 is the DIP Actions interface. Actions allow the user to pass data from the query to a JavaScript function in the portal. This component makes the DIP a very powerful tool to work with third party JavaScript APIs (1501). 1502. New Action: When clicked, the link will place an empty Action Configuration Form in the editing window. 1503. Enable simply determines whether the Action is available for use in the Viewer. 1504. Action Name This is the name of the action. If the action is not “autorun”, then this is the name that will appear on the button in the Viewer to run the action. See FIG. 26, item 2615. 1505. AutoRun: Specifies whether the action should run in Viewer when the button is clicked (deselected) or when the data in the DIP Viewer loads. 1506. Function: This is the JavaScript function that will be called and sent the specified data. To use arrays of columns values as the parameters, simply list the columns from the query preceded by a dollar sigh ($), to send static text to the function simply enclose it in single quotes (‘static value’). When the function is called in the viewer, the application will package the values from each column into a JavaScript array and call the function specified sending the arrays and any static text specified. 1507. Save: Saves the configuration entered for the action. 1508. Cancel: Warns that any unsaved information will be lost and if accepted closes the Action Configuration Form. 1509. The pencil opens the Action configuration for editing. 1510. The red X deletes the Action configuration following confirmation. 1511. The up arrow moves the Action up one level which changes the order of rendering in the Viewer accordingly. 1512. The down arrow moves the Action down one level which changes the order of rendering in the Viewer accordingly. 1513-1516. Summary information about the Actions is displayed in the Actions table.

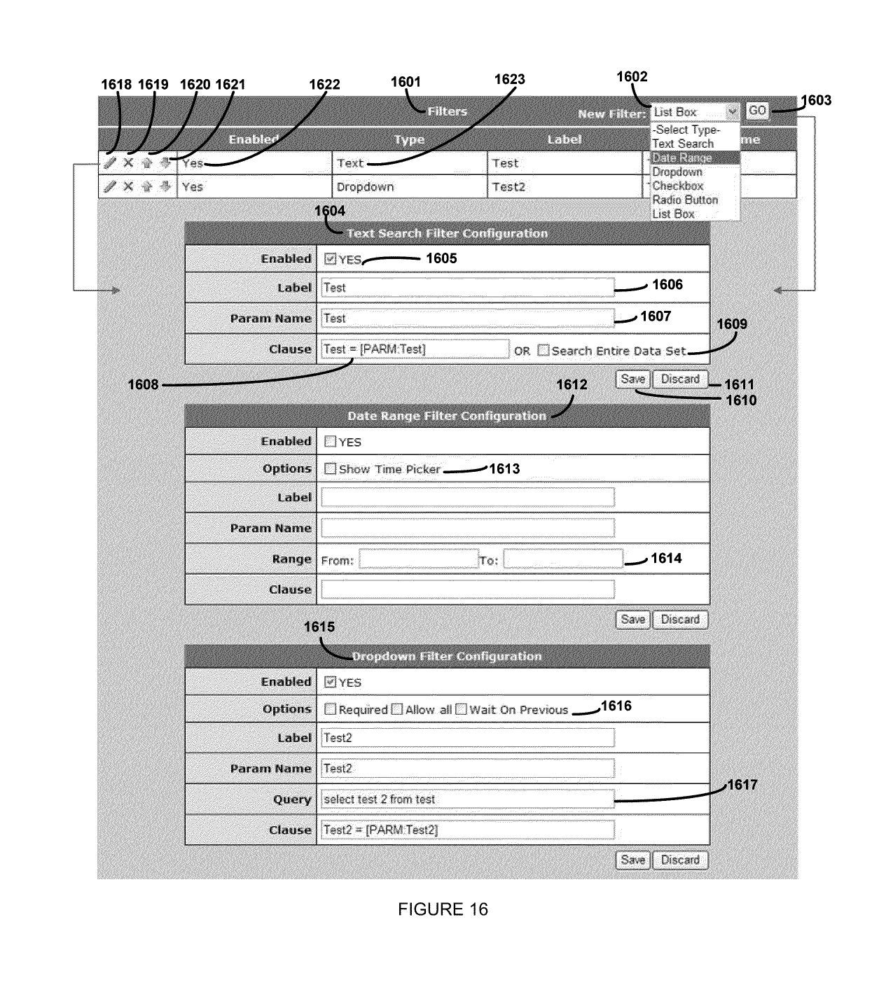

FIG. 16 shows the Filters section of the DIP Configuration Profile. Filters allow end-users to quickly get to the information they need (1601). Filters are manifested in the DIP Viewer as shown in FIG. 24, item 2401; FIG. 25, item 2502; FIG. 26 items 2605, 2606; FIG. 27 items 2701-2704. 1602. New Filter: The user selects a filter type and clicks “GO” (1603) to create a new filter for the DIP Configuration. 1604. Text Search: Text search will search the data in the Viewer as specified in the clause (1608) and returns any matching records. An example of a text filter in the Viewer may be seen in FIG. 26, item 2605. 1605. Enabled: For all filter types, determined whether or not the filter is shown in the Viewer. 1606. Label: for all filter types, specifies the label for the filter to be displayed in the Viewer. For the manifestation of this feature, see FIG. 25, item 2505 and 2506. 1607. Param Name: For all filter types, is the name of the parameter value that is set when the user enters or selects a value, this is the value that is used in the clause to apply the search to the dataset from the query. 1608. Clause: For all filter types, Clause: The clause that shall be used for the where statement for the filter. A valid clause typically consists of a column from the query, a valid operator, and the Parameter for the filter. For example, if one were to set up a filter to filter on county, it might look as follows: “County=[PARM:PCounty]”, where “County” is the column from the query and “PCounty” is the Parameter Name given to this filter. For a Text filter one might instead use: “County LIKE [PARM:PCounty] to be more inclusive given text entry issues. 1609. Search Entire Data Set: This option only applies to the text filter and performs a search against the entire data set in returned by the query, then returns any rows to the user that contain the specified search string. 1610. Save: For all filter types, saves the filter configuration entered for the action and closes the filter configuration subform. 1508. Cancel: Warns that any unsaved information will be lost and if accepted closes the filter configuration form. 1612. Date Range Filter: provides a means to filter by date range, the user in the Viewer enters a start and end date, then the system will return all records that are valid for the filter clause. An example may be seen in FIG. 25, item 2502. 1613. The Time Picker option will display a time picker in addition to the Date Picker. 1614. Range: In the Range From and To fields one can specify the default From and To dates the syntax is as follows: Now Will display today's current date and time, Yesterday Will display yesterday's date with a time of 00:00, Today Will display today's date with a time of 00:00, Tomorrow Will display tomorrow's date with a time of 00:00, D;−1 Will display 24 hours previous—yesterday's date with current time, M;−1;yyyy-MMM-dd Will display one month earlier—with no time shown. SQL will assume a time of 00:00. 1615. Dropdown Filter: This filter will provide a dropdown filter in the Viewer which will allow the user to select a value and filter accordingly. For san example of this se FIG. 26, item 2606. 1616. Options: Required: Is an option for the Dropdown, Checkbox, Radio Button, and Listbox filter types. Selecting it will require the user to select or check an item in the filter prior to displaying any data. This is useful for large data sets. It also saves performing a query when the data is only relevant when a filter is executed. Allow All: Is an available option on the Dropdown, Checkbox, and Listbox filter types that will insert an “ALL” option to the top of the list of choices. Wait on Previous: Is presented on all filters except for the first. The effect of “Wait on Previous” is to not load the options for Dropdown, Checkbox, Radio Button, and Listbox, until the previous item has been entered thus allowing for hierarchical filtering, an example might be a Company, Division, Location filter set, where Division list would not be presented until Company was chosen, and likewise Location list would not be populated until Division is selected. An example of the Viewer implementation of this feature can be seen in FIG. 27, items 2702-2704 where District only shows those Districts for Rep Name, and School only shows those Schools that apply to the selected Districts. 1617. Query: For Dropdown, Checkbox, Radio, and Listbox the Query field is where a valid SQL query is user to populate the filter options with values. For non-database driven options text may be entered in the form of a database query. Instructions are provided for this in the context help for the filter section. 1618. The pencil opens the Filter configuration for editing. 1619. The red X deletes the Filter configuration following confirmation. 1620. The up arrow moves the Filter up one level which changes the order of rendering in the Viewer accordingly. 1621. The down arrow moves the Filter down one level which changes the order of rendering in the Viewer accordingly. 1622 & 1623. Summary information about the Filter is displayed in the Filters table.

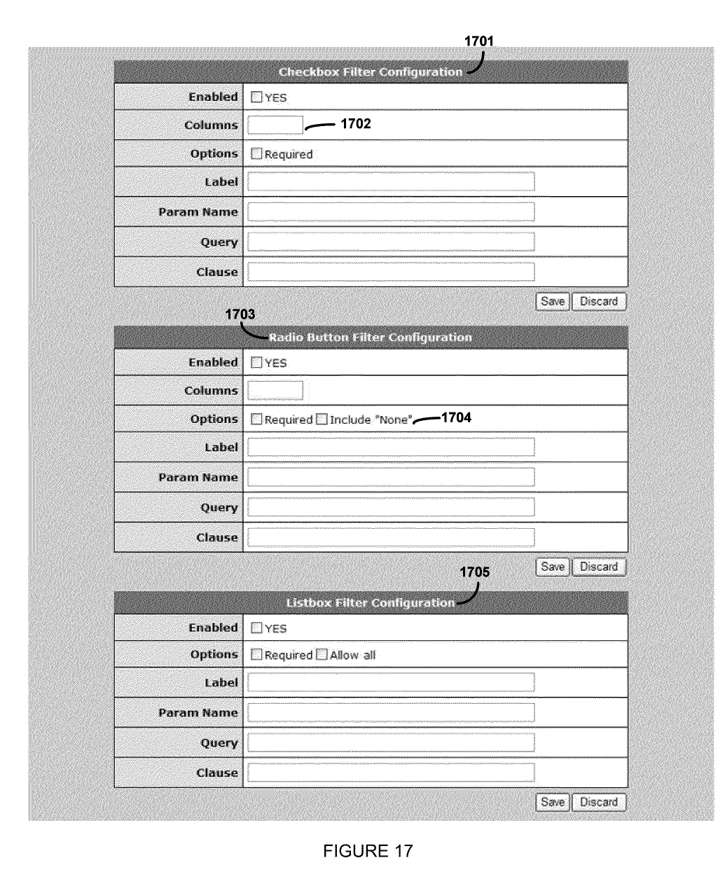

FIG. 17 is a continuation of the Filter Section interface. 1701: Checkbox Filter: Presents a checkbox filter in the Viewer. An example of this may be seen in FIG. 27, items 2701 and 2702. 1702. Columns: For checkbox and radio button filter type the columns parameter specifies how many columns will be presented to the user in the Viewer. For example in FIG. 27, item 2701 four columns are specified, in 2702 one column is specified, if left blank, one column is assumed. 1703. Radio Button Filter: Is similar to checkbox, except that a radio button is rendered instead. The only exception to the configuration is that an Include None option is available to deselect all items from the radio button since this is not natively support by the radio button object in the browser. 1704. Listbox Filter: This filter type allows the user to hold down the control or shift key on their keyboard and select multiple items. Examples can be seen in FIG. 24, item 2401; FIG. 27, items 2703 and 2704.

FIG. 18 shows the Header/Footer (1801) and Stylesheet sections (1805). The header and footer allow one to display information above, centrally, and below the output table in the Viewer. The header, center, and footer can accept text valid HTML. In fact, many users use these areas to add JavaScript or extensive HTML to their portal pages. 1802. Header: Any text entered here will be displayed at the top of the DIP Viewer as shown in FIG. 26, item 2601. 1803. Center: Any text entered here will be displayed between the Filters area and the grid area in the Viewer. For example in FIG. 24, item 2405, a JavaScript charting application has been entered into the Center area and displays charts using the Actions feature of the DIP. 1804. Footer: The footer section will display and entered text or HTML below the grid that is rendered in the Viewer. See FIG. 24, item 2408 for an example. 1806. Set to Portal: This button will take the styles from the portal and embed them into the DIP Configuration stylesheet. 1807. Reset to Default: This will set the stylesheet (1810) back to the default stylesheet that was shipped with the DIP product. 1808. Set to Master will set the stylesheet (1810) to the master styles that were saved previously by clicking Set as Master. 1809. Save as Master: This will save the current stylesheet (1810) as the Master. Subsequent clicking on the Set to Master button (1808) will use these styles. 1810. Stylesheet: The DIP configuration uses the default stylesheet shipped with the product, but users can replace or modify the look and feel to meet there needs by modifying the styles in this field. The various CSS classes control the entire look-and-feel of the Viewer. Any valid CSS attributes may be used as specifies by the W3C or the various vendor browsers that the Viewer will use for presentation of the portal. FIGS. 24 through 29 exemplify this through the use of different colors. 1811. The Save button will perform a validation to ensure that all requirements for submission have been met, then call the save function and pass all the configured parameters, the application will then write these parameters to an encrypted XML file and save it in the DIP configuration directory on the server. 1812. Save and Close: Performs the same function as save, but will additionally return the user to the Configuration Manager.

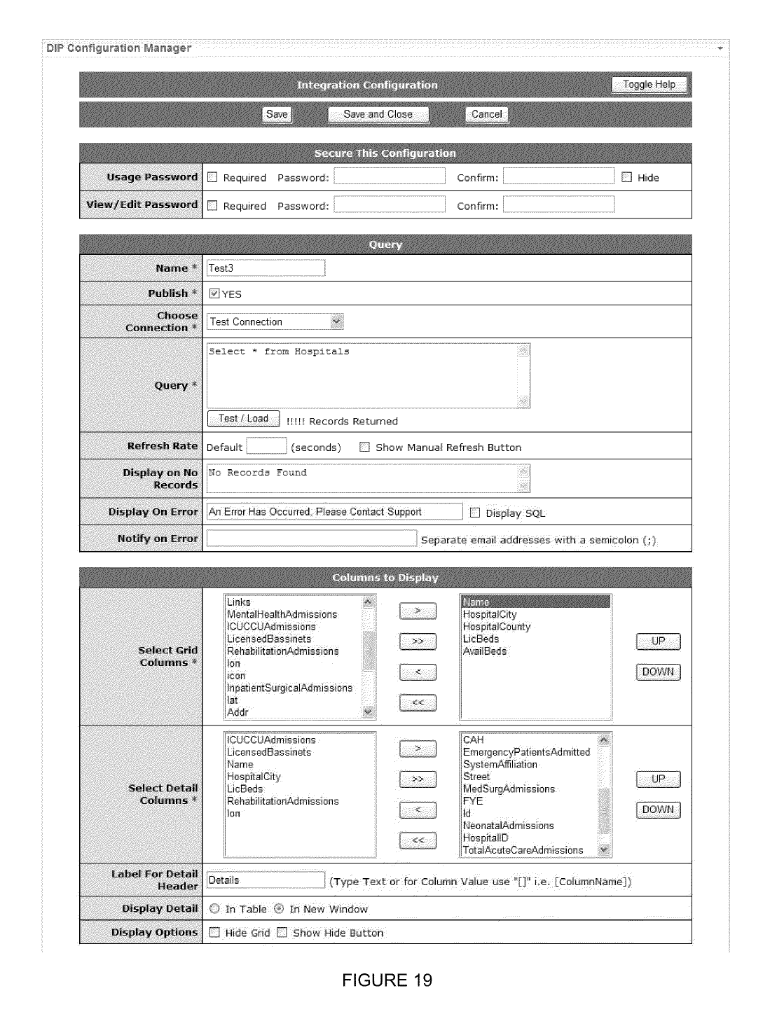

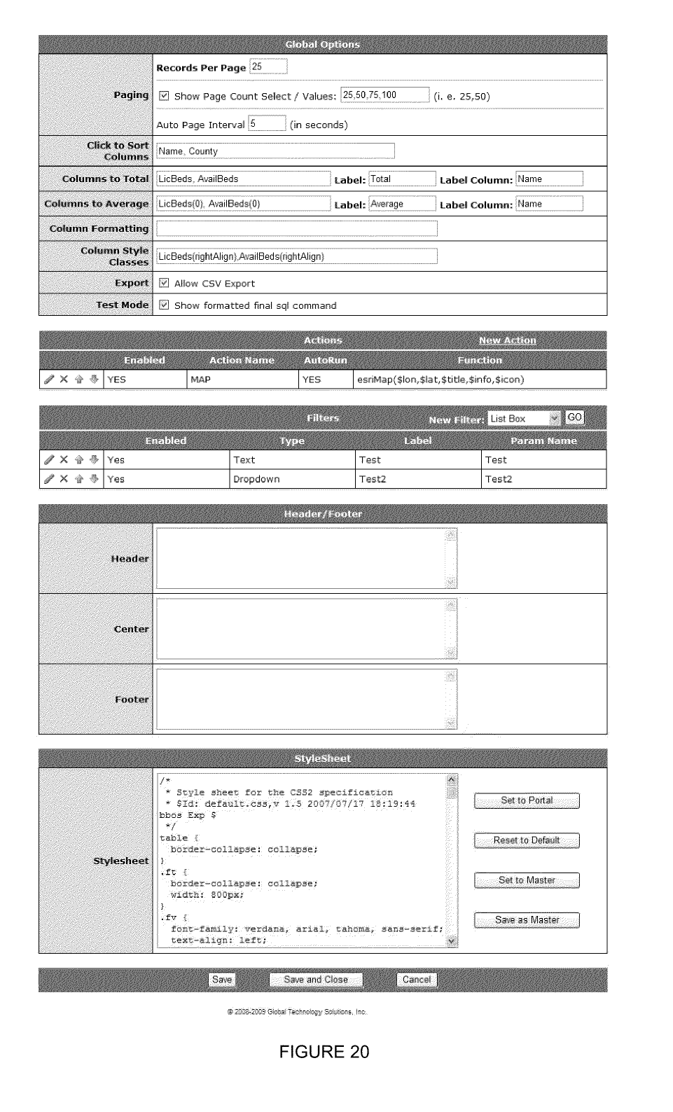

FIG. 19 is a screenshot off one half of the DIP Configuration Profile for purposes of getting an overall sense of what is presented to the DIP Configuration Administrator. FIGS. 19 and 20 are included to provide a “50,000 foot view” of the Configuration Interface.

FIG. 20 is the second half of the DIP Configuration Profile to serve the same purpose as FIG. 19.

FIG. 21 is a screenshot showing the robust built in help facility for the Configuration Profile that embeds help text exactly where it's needed, just like on the Connection Profile. 2101. Toggle Help: The toggle help button turns the context sensitive help on and off. 2102. Shows the actual help text displayed.

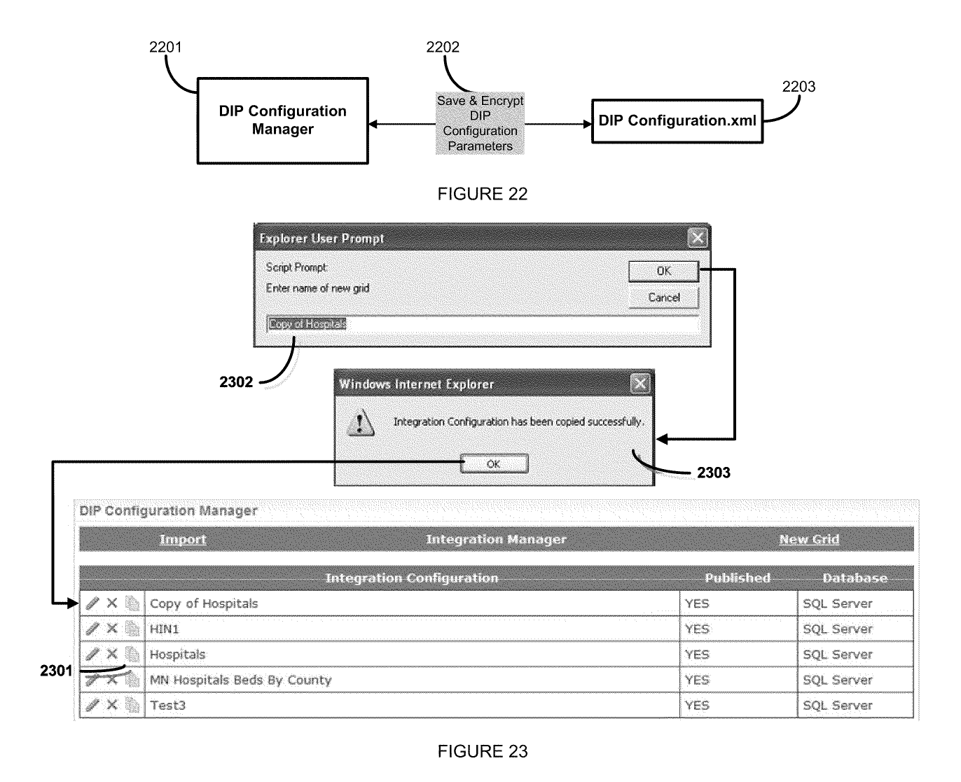

FIG. 22 shows the architecture and on-save event processing that saves the configuration parameters to the encrypted XML file on creation or updating of a configuration profile. The DIP Configuration Form (2201) parameters are passed to the DIP application Java Servlet (2202), which then performs encryption, and saves the result in the DIP Configuration XML file (2203).

FIG. 23 shows the copy feature of the Configuration Manager which permits the Configuration Administrator to copy an existing Configuration as a starting point for creating a new DIP. 2301. Copy Icon: To make a copy of a configuration the user clicks the copy icon. 2302. Name New Configuration: Because the Configuration names must be unique, the user enters a new name. 2203. Confirmation: The copy is confirmed to the user and the copy of Configuration is added to the Configuration manager table.

FIG. 24 is a screenshot of the DIP Viewer Named Portlet Instance with which the end-user shall interact to view the information as configured in the assigned (mapped) configuration. It also demonstrates the Action sending query data to a JavaScript charting API. 2401. Listbox Filter: The user may select values and then click Filter Now (2402) to filter the data in the grid by the items selected. When the grid is rendered, the DIP will send the data in the visible grid to the chart's JavaScript API to render the chart. 2406. This shows the rendered total that was specified in the Configuration. 2407. This shows the rendered average that was specified in the Configuration. 2408. Shows the Footer text that was entered in the Configuration profile. 2409. The << button in the footer is disabled on the first data page, on subsequent pages it will return the user to the first page. 2410. The < button in the footer is disabled on the first data page, on subsequent pages it will return the user to the previous page. 2411. Page dropdown allows the user to select the page to which they would like to navigate. On Change the dropdown calls the loader functions and loads the selected data page. 2412. The >> button in the footer is disabled on the last data page, on prior pages it will return the user to the last page. 2413. The < button in the footer is disabled on the last data page, on previous pages it will return the user to the subsequent page. 2414. If Detail has been specified in the configuration, the Expand All button will expand all rows revealing all of the detail. To view the detail for a single row, the hourglass icon (FIG. 27, item 2507) is clicked. 2415. Collapse All functions similarly, to Expand All, but it collapses all Detail Sections effectively hiding them from view. 2416. The Export to CSV button will appear if specified in the Configuration profile for the DIP Viewer, when clicked it will process and download to the browser causing the browser to present the user with an Open/Save/Cancel dialog box. 2417. If specified in the Configuration Profile, the Hide Grid button will be shown, and when clicked it will hide the grid. This is useful when there are a large number of rows and perhaps more data in another portlet below.

FIG. 25 is another DIP Viewer Named Portlet Instance that demonstrates the Date Range filter and column formatting. 2501. The Title of the column may be clicked to resort the grid by the clicked column. Clicking again reverses the sort order. When sorting is completed the user is returned to the first data page. 2503. Shows a column that uses a different CSS class specified in the Configuration Profile to right align the numbers.

FIG. 26 shows a DIP Viewer Named Portlet Instance that is facilitating the mapping of points (hospitals) to an ESRI map leveraging the ESRI JavaScript API. 2601. Shows the header text that was specified in the configuration. 2602. The Name of the Configuration is displayed in the header of the grid. 2603. If specified in the configuration the user is presented with a dropdown list of values that determine how many rows of records will appear on a given page. 2304. The “Go” button reloads the paging to the selected number of rows. 2305. A text filter is shown that was created in the configuration. 2606. A dropdown filter is shown that was created in the configuration. 2607. Clicking on filter now will cause the DIP application to add the filter criteria to the query and re-query the database using the new query syntax. Reset will put all filter values back to their defaults. 2608. Allows a user to save a filter configuration so that it may be selected at a later time in lieu of re-entering and re-selecting the filter parameters. 2609. The users previously saved filter are presented ion this dropdown list where they may be selected, when “GO” is clicked the saved values are entered into the filter fields and the Filter Now function is executed. 2610. If the user selects a saved filter and clicks the delete button the saved filter will be removed following confirmation. 2611. The Hide button hides the filter section. 2612. The Refresh button will appear if specified to do so in the configuration. On click, it will reissue the current query and re-render the data into the grid. 2613. When an Action is specified to not AutoRun, a checkbox is rendered on each row. The user may then select specific records, or check the box in the header (2614) to select all records, and then may click the Action button (2615) to run the Action that was specified in the configuration. In this case the specified function is to send Iat, Ion, icon, title, and info box content to the ESRI mapping API. Multiple actions can be configured for a single DIP configuration.

FIG. 27 demonstrates the ability of the DIP Viewer Named Portlet Instance to support cascading or dependent filtering, and the display of detailed information within the portlet for a given record. 2701. Shows a checkbox filter rendered in four columns. 2702-2704. Shows dependent or cascading filter controls. The District and School Name filters are configured for wait on above and therefore will only execute thr respective queries when the filter above has been selected. This allows one to restrict a given filters options to those entries which apply to the prior selection (like Company, Division, Location). 2705. When the user clicks the hourglass icon the detail is displayed in the case the detail was set to “In Table” in the configuration causing the row to expand revealing the detail section (2706) from the configuration as specified. 2707. The printer icon allows the detail to be opened in a new window for printing in order to exclude the rest of the portal interface from the printed document.

FIG. 28 is the detail that is displayed when “Detail in new window” is configured. The printer icon in this case will invoke the users operating system to display a print dialog box.

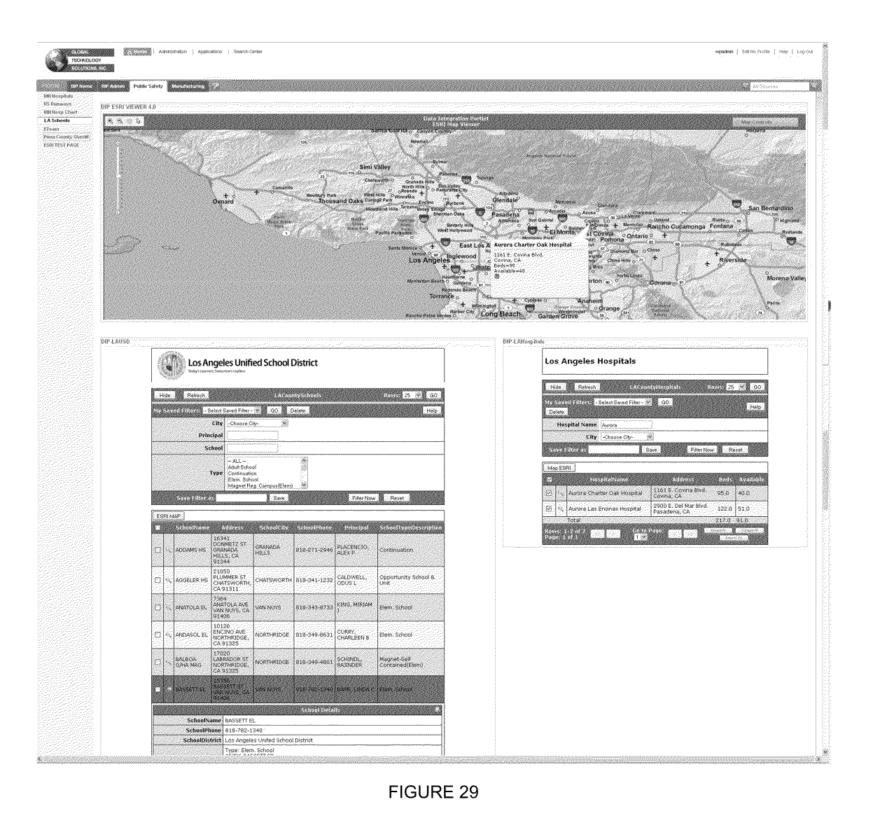

FIG. 29 is intended to show an overview of the portal leveraging DIP technology.

In view of the foregoing, it will be appreciated that present invention provides significant improvements in data acquisition and visualization. It should be understood that the foregoing relates only to the exemplary embodiments of the present invention, and that numerous changes may be made therein without departing from the spirit and scope of the invention as defined by the following claims.

1. Data integration Toolkit Comprising:
a. A securable connection form that permits users to create a database connection. Then secure that connection by entering a password
b. Encryption mechanism that uses a user entered password as the encryption key for storing connection configuration parameters.
c. A data Integration Configuration form that permits users to create a query; then set display, formatting, and event options for the display of the queried data in a data viewer without software development.
d. Encryption mechanism that uses a user entered password as the encryption for key for storing data configuration parameters.
e. A data Viewer that retrieves the connection and configuration parameters and then performs the query and formats the user interface and the data as specified in the configuration profile.

2. A Data Integration Toolkit of claim 1, wherein A mechanism is provided to call and send all or a portion of the data to a third party JavaScript API.

3. A Data Integration Toolkit of claim 1, wherein the entire application is Zero-Footprint meaning that it requires no database to be installed and run.

4. A Data Integration Toolkit of claim 1, wherein the application can acquire, secure, and display data within a portal environment without requiring the user to write any code other than SQL.
